(19) United States
(12) Patent Application Publication
(10) Pub. No.: US 2023/0393878 A1
(43) Pub. Date: Dec. 7, 2023

(54) DYNAMIC ACCESS-POINT CONFIGURATION WITH CONTAINERIZED APPLICATIONS

(71) Applicant: ARRIS Enterprises LLC, Suwanee, GA (US)

(72) Inventors: Dinesh Raman, Fremont, CA (US); Sanjay Gandotra, Santa Clara, CA (US)

(73) Assignee: ARRIS Enterprises LLC, Suwanee, GA (US)

(21) Appl. No.: 18/206,111

(22) Filed: Jun. 6, 2023

Related U.S. Application Data
(60) Provisional application No. 63/349,157, filed on Jun. 6, 2022.

(51) Int. Cl. G06F 9/455; H04L 9/40

(52) U.S. Cl. CPC G06F 9/45558; H04L 63/0281; G06F 2009/45595

(57) ABSTRACT

A computer system (such as a controller) that dynamically configures a computer network device with a containerized data-driven application and associated metadata is described. During operation, the computer system may receive information specifying the containerized data-driven application. Then, the computer system may receive second information specifying metadata associated with the containerized data-driven application. For example, the second information may include one or more modifications to predefined metadata. Moreover, the computer system may perform authentication using an authentication proxy. Next, the computer system may obtain, in a cloud-based registry of containerized data-driven applications, the containerized data-driven application. Furthermore, the computer system may provide, addressed to the computer network device, the containerized data-driven application and the metadata.

### CROSS REFERENCE TO RELATED APPLICATIONS

This application claims priority under 35 U.S.C. 119(e) to U.S. Provisional Application Ser. No. 63/349,157, “Dynamic Access-Point Configuration with Containerized Applications,” filed on Jun. 6, 2022, by Dinesh Raman et al., the contents of which are herein incorporated by reference.

### FIELD

The described embodiments relate to techniques for communication. Notably, the described embodiments relate to techniques for dynamically configuring an access point (or a computer network device) with a containerized data-driven application and associated metadata.

### BACKGROUND

The increasing capabilities of electronic devices are dramatically changing our lives. For example, the processing and communication capabilities of portable electronic devices, such as cellular telephones, provide users with the capabilities of a handheld computer. In conjunction with expanded networks, such as the cellular-telephone networks and the Internet, these capabilities are allowing individuals to: access vast amounts of information: identify and interact with other people, organizations and governments; access information at arbitrary locations; and/or perform a wide variety of tasks. Collectively, these technologies have resulted in a significant increase in economic activity (such as online financial transactions, which are sometimes referred to as ‘ecommerce’) and productivity, and enable a host of applications that enhance user experiences and quality of life.

Recently, it has been proposed that further advances can be achieved by enhancing the capabilities of other electronic devices, which are pervasive but largely ignored by most users (such as in appliances, infrastructure, transportation, farming, etc.). Notably, by embedding sensors, actuators and communication capabilities in these ‘background’ electronic devices, the so-called ‘Internet of things’ (IoT) can provide a distributed network that facilities the exchange of data, remote sensing and control, and a diverse set of applications that facilitate more direct integration of the physical world into computer-based systems. In principle, the IoT offers the promise of highly automated systems that improve efficiency, enhance accuracy and expand economic activity in a diverse set of markets, such as: smart cities, hospitality, retail, education, housing, and manufacturing.

In practice, there are still obstacles to achieving the goals of the IoT. Notably, the IoT marketplace is diverse, with competing commercial entities offering devices/endpoints, networks, middleware and cloud-based platforms and services. Moreover, the marketplace lacks interoperability standards, which restricts communication and the exchange of data among components in these systems. The resulting lack of coordination can make it difficult to scale IoT systems while maintaining or ensuring quality of service.

Consequently, the IoT remains fragmented and siloed, which forces users to purchase additional dedicated equipment (such as separate gateways for electronic devices from different manufacturers and providers, and/or additional network switches to connect to different cloud-based service providers) in an attempt to build integrated solutions. However, these efforts often result in custom (e.g., vendor-specific) and expensive solutions with redundant equipment, limited flexibility and difficulty in scaling to large deployments, all of which is frustrating to users and limits market traction of the IoT.

### SUMMARY

A computer system that dynamically configures a computer network device with a containerized data-driven application and associated metadata is described. This computer system includes: an interface circuit that communicates with the computer network device; a processor; and memory that stores program instructions, where, when executed by the processor, the program instructions cause the computer system to perform one or more operations. Notably, during operation, the computer system receives information specifying the containerized data-driven application. Then, the computer system receives second information specifying metadata associated with the containerized data-driven application. Moreover, the computer system perform authentication using an authentication proxy. Next, the computer system obtains, in a cloud-based registry of containerized data-driven applications, the containerized data-driven application. Furthermore, the computer system provides, addressed to the computer network device, the containerized data-driven application and the metadata.

Note that the computer network device may include: an access point, a gateway or a router.

Moreover, the metadata may specify resources that the containerized data-driven application is allowed to use on the computer network device, such as: an amount of memory, a number of socket connections, a number of file managers, etc.

Furthermore, the containerized data-driven application may execute in a virtual machine for the containerized data-driven application. This virtual machine may include an operating system for the containerized data-driven application.

Additionally, the metadata may be constrained based at least in part on one or more of: resources of the computer network device, one or more other applications installed on the computer network device, or one or more functions of the computer network device.

In some embodiments, the computer system may include a controller of the computer network device. This controller may configure and manage operation of the computer network device.

Note that the containerized data-driven application may include: Bluetooth low energy (BLE) monitoring of a BLE tag, a firewall, an analytics application, a radio resource manager that communicates using a communication protocol, or another micro-service.

Moreover, the containerized data-driven application may be securely obtained from the cloud-based registry.

Furthermore, the containerized data-driven application may extend the functionality of the computer network device beyond an initial set of predefined functions associated with hardware in the computer network device.

Additionally, the receiving of the information and/or the second information may occur via a user interface.

In some embodiments, the second information may specify one or more modifications to predefined metadata.

Another embodiment provides the computer network device that performs counterpart operations to at least some of the operations performed by the computer system in one or more of the preceding embodiments.

Another embodiment provides the authentication proxy that performs counterpart operations to at least some of the operations performed by the computer system in one or more of the preceding embodiments.

Another embodiment provides the cloud-based registry that performs counterpart operations to at least some of the operations performed by the computer system in one or more of the preceding embodiments.

Another embodiment provides a user interface that facilitates performing at least some of the operations performed by the computer system.

Another embodiment provides a computer-readable storage medium with program instructions for use with the computer system or the computer network device. When executed by the computer system or the computer network device, the program instructions cause the computer system or the computer network device to perform at least some of the aforementioned operations or corresponding counterpart operations in one or more of the preceding embodiments.

Another embodiment provides a method, which may be performed by the computer system or the computer network device. This method includes at least some of the aforementioned operations or counter operations in one or more of the preceding embodiments.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices in accordance with an embodiment of the present disclosure.

FIG. 2 is a drawing illustrating an example of functionality of an access point in FIG. 1 in accordance with an embodiment of the present disclosure.

FIG. 3 is a block diagram illustrating an example of an Internet-of-Things (IoT) services manager of FIG. 1 in accordance with an embodiment of the present disclosure.

FIG. 4 is a block diagram illustrating an example of a software architecture of the services manager of FIGS. 1 and 3 in accordance with an embodiment of the present disclosure.

FIG. 5 is a drawing illustrating an example of an onboarding workflow in accordance with an embodiment of the present disclosure.

FIG. 6 is a drawing illustrating an example of a deployment architecture in accordance with an embodiment of the present disclosure.

FIG. 7 is a flow diagram illustrating an example of a method for dynamically generating an application in accordance with an embodiment of the present disclosure.

FIG. 8 is a drawing illustrating an example of communication among the electronic devices in FIG. 1 in accordance with an embodiment of the present disclosure.

FIG. 9 is a drawing illustrating an example of a user interface that facilitates dynamic generation of an application in accordance with an embodiment of the present disclosure.

FIG. 10 is a flow diagram illustrating an example of a method for dynamically configuring a computer network device with a containerized data-driven application and associated metadata in accordance with an embodiment of the present disclosure.

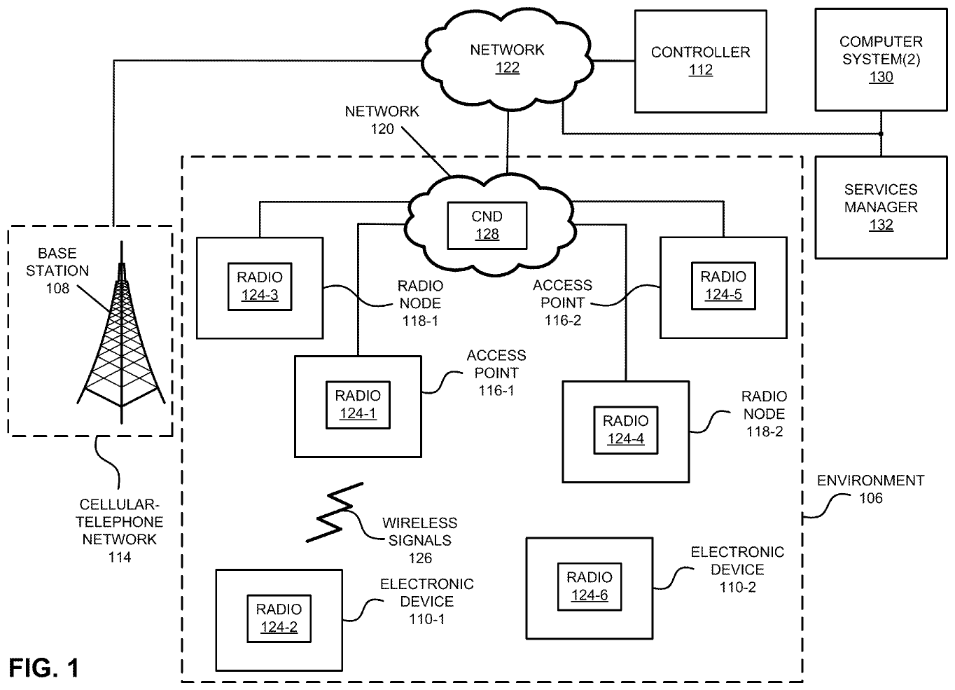

FIG. 1I is a drawing illustrating an example of communication among the electronic devices in FIG. 1 in accordance with an embodiment of the present disclosure.

FIG. 12 is a drawing illustrating an example of communication among the electronic devices in FIG. 1 in accordance with an embodiment of the present disclosure.

FIG. 13 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

A computer system (such as a controller) that dynamically configures a computer network device with a containerized data-driven application and associated metadata is described. During operation, the computer system may receive information specifying the containerized data-driven application. Then, the computer system may receive second information specifying metadata associated with the containerized data-driven application. For example, the second information may include one or more modifications to predefined metadata. Moreover, the computer system may perform authentication using an authentication proxy. Next, the computer system may obtain, in a cloud-based registry of containerized data-driven applications, the containerized data-driven application. Furthermore, the computer system may provide, addressed to the computer network device, the containerized data-driven application and the metadata.

By dynamically configuring the computer network device, these communication techniques may allow functions of the computer network device to be changed or modified on the fly. These capabilities may allow the functions of the computer network device to be extended beyond initial predefined functions of the computer network device. Thus, the communication techniques may dynamically repurpose the computer network device, so the computer network device has or can provide improved and/or additional capabilities or services. Consequently, the communication techniques may improve the user experience when using the computer network device and may enable the IoT.

In the discussion that follows, electronic devices or components in a system (such as an access point, a router, a gateway or a network gateway, a radio node, e.g., an eNodeB, or another type of computer network device) communicate frames or packets in accordance with one or more wireless communication protocol, such as an IEEE 802.11 standard (which is sometimes referred to as ‘Wi-Fi,’ from the Wi-Fi Alliance of Austin, Texas), Bluetooth (from the Bluetooth Special Interest Group of Kirkland, Washington), BLE (from the Bluetooth Special Interest Group of Kirkland, Washington), an IEEE 802.15.4 standard (which is sometimes referred to as Zigbee), Z-Wave (from Sigma Designs, Inc. of Fremont, California), LoRaWAN (from the Lora Alliance of Beaverton, Oregon), Thread (from the Thread Group of San Ramon, California), IPv6 over low-power wireless personal area networks or 6LoWPAN (from the Internet Engineering Taskforce of Fremont, California) a cellular-telephone network or data network communication protocol (such as a third generation or 3G communication protocol, a fourth generation or 4G communication protocol, e.g., Long Term Evolution or LTE or 5GC (from the 3rd Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11 g, IEEE 802.11-2007, IEEE 802.1In, IEEE 802.11-2012, IEEE 802.11-2016. IEEE 802.11ac, IEEE 802.11ax, IEEE 802.11ba, IEEE 802.11be, or other present or future developed IEEE 802.11 technologies.

Moreover, an access point, a radio node, a base station or a switch in the wireless network and/or the cellular-telephone network may communicate with a local or remotely located computer system (such as a controller) using a wired communication protocol, such as a wired communication protocol that is compatible with an IEEE 802.3 standard (which is sometimes referred to as ‘Ethernet’), e.g., an Ethernet II standard, Message Queueing Telemetry Transport (MQTT) and/or another type of wired interface. However, a wide variety of communication protocols may be used in the system, including wired and/or wireless communication. In the discussion that follows, Wi-Fi and Ethernet are used as illustrative examples.

In the discussion that follows, note that a ‘virtual machine’ is a compute resource that uses software instead of a physical computer to run programs and deploy applications. One or more virtual machines may run on a physical ‘host’ machine or computer. Each virtual machine may run its own operating system and functions separately from the other virtual machines, even when they are all running on the same host. For example, this means that a type of operating system in a virtual machine can run on a physical machine or computer that runs a second type of operating system.

Moreover, note that a virtual machine may virtualize an entire machine down to the hardware layers, while a container may only virtualize software layers above the operating system level. Consequently, a container may provide a way to virtualize an operating system so that multiple workloads can run on a single operating-system instance. In contrast, with virtual machines, the hardware is virtualized to run multiple operating-system instances.

We now describe some embodiments of the communication techniques. FIG. 1 presents a block diagram illustrating an example of communication in an environment 106 with one or more electronic devices 110 (such as cellular telephones, portable electronic devices, stations or clients, another type of electronic device, etc.) via a macrocell in a cellular-telephone network 114 (which may include a base station 108), one or more access points 116 (which may communicate using Wi-Fi) in a WLAN and/or one or more radio nodes 118 (which may communicate using LTE) in another cellular-telephone network (such as a small-scale network or a small cell). For example, the one or more radio nodes 118 may include: an Evolved Node 13 (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘computer network device.’ Moreover, one or more base stations (such as base station 108), access points 116, and/or radio nodes 118 may be included in one or more wireless networks, such as: a WILAN and/or a cellular-telephone network. In some embodiments, access points 116 may include a physical access point and/or a virtual access point that is implemented in software in an environment of an electronic device or a computer.

Note that access points 116 and/or radio nodes 118 may communicate with each other and/or controller 112 (which may be a local or a cloud-based controller that manages and/or configures access points 116, radio nodes 118 and/or a computer network device (CND) 128, or that provides cloud-based storage and/or analytical services, and thus that may include one or more computers at one or more locations) using a wired communication protocol (such as Ethernet) via network 120 and/or 122. Alternatively, or additionally, access points 116 and/or radio nodes 118 may communicate with one or more computer systems 130 (which may be associated with service providers or third parties, and which are sometimes referred to as ‘providers’) using the wired communication protocol. However, in some embodiments, access points 116 and/or radio nodes 118 may communicate with each other, controller 112 and/or computer system 130 using wireless communication (e.g., one of access points 116 may be a mesh access point in a mesh network). In some embodiments, access points 116 and/or radio nodes 118 may communicate with services manager 132 (which may be a local or a cloud-based, and which may include one or more computers at one or more locations) using a wired communication protocol (such as Ethernet) via network 120 and/or 122. Note that networks 120 and 122 may be the same or different networks. For example, networks 120 and/or 122 may include an LAN, a mesh network, point-to-point connections, an intra-net or the Internet. In some embodiments, network 120 may include one or more routers and/or switches (such as computer network device 128).

As described further below with reference to FIG. 13, electronic devices 110, controller 112, access points 116, radio nodes 118, computer network device 128, the one or more computer systems 130 and/or services manager 132 may include subsystems, such as a networking subsystem, a memory subsystem and a processor subsystem. In addition, electronic devices 110, access points 116 and radio nodes 118 may include radios 124 in the networking subsystems. More generally, electronic devices 110, access points 116 and radio nodes 118 can include (or can be included within) any electronic devices with the networking subsystems that enable electronic devices 110, access points 116 and radio nodes 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc. Note that while instances of radios 124 are shown in electronic devices 110, access points 116 and radio nodes 118, one or more of these instances may be different from the other instances of radios 124.

During the communication in FIG. 1, access points 116 and/or radio nodes 118 and electronic devices 110 may wired or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include information as payloads). In some embodiments, the wireless communication, e.g., by access points 116, may involve the use of dedicated connections, such as via a peer-to-peer (P2P) communication techniques.

As can be seen in FIG. 1, wireless signals 126 (represented by a jagged line) may be transmitted by radios 124 in, e.g., access points 116 and/or radio nodes 118 and electronic devices 110. For example, radio 124-1 in access point 116-1 may transmit information (such as one or more packets or frames) using wireless signals 126. These wireless signals are received by radios 124 in one or more other electronic devices (such as radio 124-2 in electronic device 110-1). This may allow access point 116-1 to communicate information to other access points 116 and/or electronic device 110-1. Note that wireless signals 126 may convey one or more packets or frames. Moreover, access point 116-1 may allow electronic device 110-i to communicate with other electronic devices, computers, computer systems and/or servers via networks 120 and/or 122.

In the described embodiments, processing a packet or a frame in access points 116 and/or radio nodes 118 and electronic devices 110 may include: receiving the wireless signals with the packet or the frame; decoding/extracting the packet or the frame from the received wireless signals to acquire the packet or the frame; and processing the packet or the frame to determine information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or resend rate), a mean-squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as, but not limited to: 900 MHz, 2.4 GHz, 5 GHz, 6 GHz, 7 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA) and/or multiple input, multiple output (MIMO) communication.

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

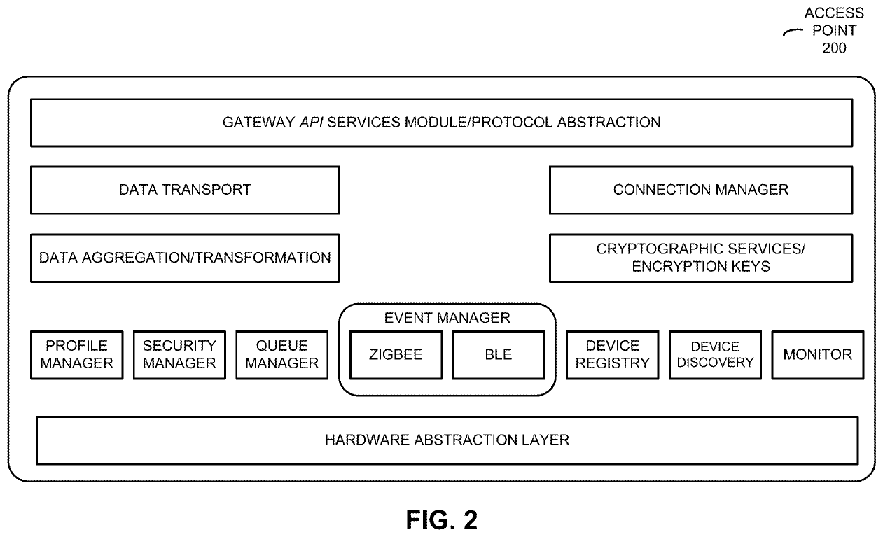

As noted previously and as described further below with reference to FIG. 2, one of access points 116 (such as access point 116-1) may perform at least some aspects of the communication techniques. This may allow access points 116 to become one-touch points of access to the IoT using a single framework. Notably, access points 116 may facilitate the dynamic integration of multiple electronic devices and service providers in a variety of applications, as well as easy deployment and upgrades.

In some embodiments, access point 116-1 may provide co-existing or concurrent communication using different communication protocols. Notably, access point 116-1 may include one or more radios, such as radio 124-1. These radios may, respectively, communicate using different communication protocols in a shared band of frequencies (such as the 2.4 GHz ISM band of frequencies, the 5 GHz band of frequencies and/or the 6 GHz band of frequencies). For example, a first radio may be a BLE radio and a second radio may be a Wi-Fi radio. During operation, the first radio may perform a scan of available channels in the shared band of frequencies. The second radio may detect or determine that BLE and Wi-Fi may each use one of primary channels 1, 6 and 11 (such as channel 1). Alternatively, the second radio may receive, from the first radio, information specifying one or more used channels in the shared band of frequencies that are reserved or used by the BLE communication protocol. Next, the second radio may mask the one or more used channels from the available channels (such as by masking out 8-16 MHz corresponding to primary channel 1), and the second radio may select one or more channels from remaining available channels for use with the Wi-Fi communication protocol, such as a new primary channel. Thus, because Wi-Fi has the ability to hop among different channels while BLE and Zigbee typically do not hop, channel masking may be used to facilitate co-existing and/or concurrent communication among access points 116 and electronic devices 110 using two different communication protocols in the shared band of frequencies.

While access point 116-1 may include two separate radios, in some embodiments these radios are combined into a single radio or integrated circuit. Alternatively or additionally, packet-traffic arbitration between the two radios may be used. Notably, when one of the radios is transmitting or receiving using a channel and a first communication protocol, it may communicate a hold (such as a hold signal or instruction) to the other radio, so that the other radio temporarily does not communicate using the channel and a second communication protocol.

In some embodiments, additional communication capability is added to access point 116-1 via a plug-in module, such as a dongle (which is sometimes referred to as a ‘USB dongle’) that is inserted into a USB port in access point 116-1. For example, radio 124-1 may be a USB dongle that adds BLE communication capability to access point 116-1. In conjunction with software on access point 116-1, this may enable communication-protocol recognition and translation, as well as communication via another communication protocol (as was just described).

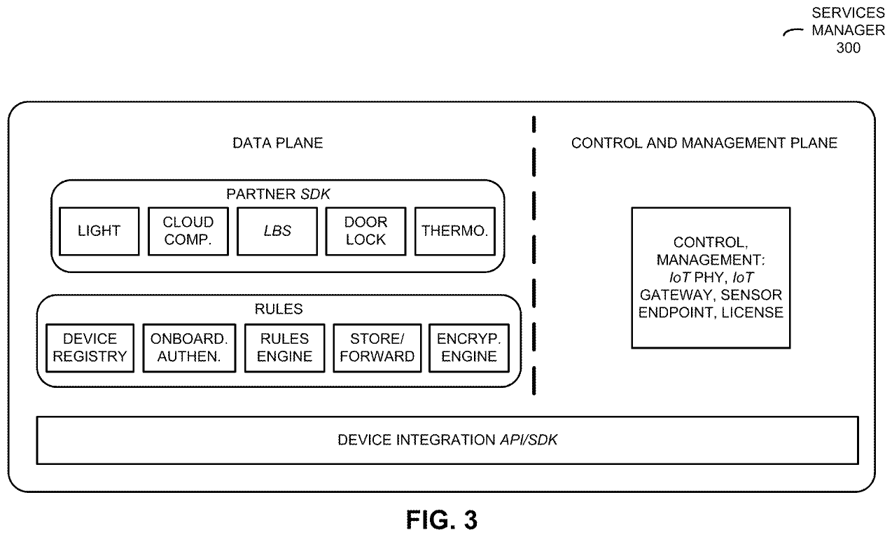

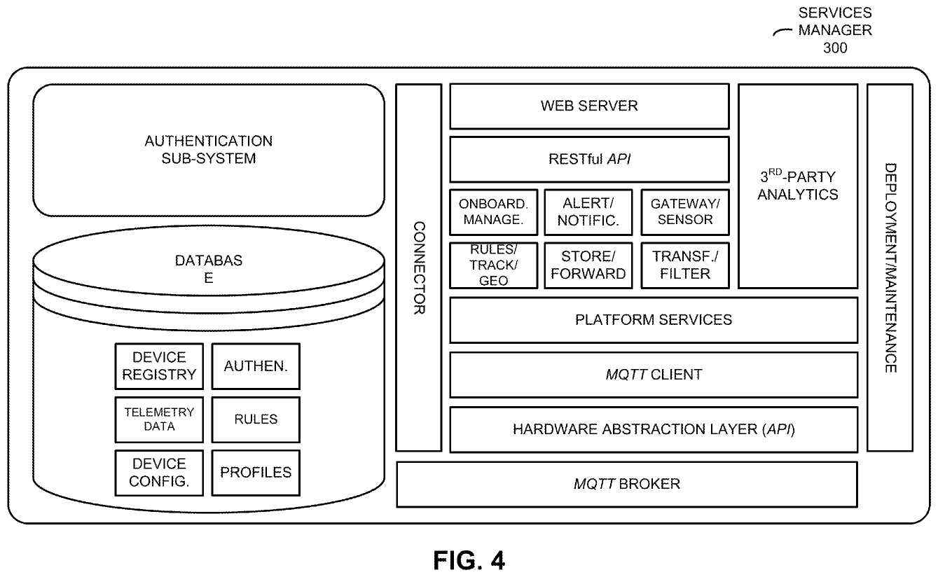

Moreover, as described further below with reference to FIGS. 3 and 4, additional infrastructure may perform or implement at least some aspects of the communication techniques. Notably, services manager 132 may enable dynamic integrated solutions with disparate (and otherwise potentially incompatible) components, such as one or more sensors (which are sometimes referred to as an ‘IoT device’) and/or actuators from different manufacturers (which are sometimes referred to as an ‘IoT device’), and/or one or more service providers. These different components may be associated with different (unrelated) entities, such as different companies or organizations. Note that in the present discussion an ‘IoT device’ may have a sensing capability and/or an actuation capability.

Notably, services manager 132 may include: a gateway that communicates with one or more of access point 116 via a communication protocol (such as MQTT); a control and management plane with system-configuration information; and a data plane with a registry of the one or more electronic devices 110, rules for the one or more electronic devices 110, and application programming interfaces (APIs) for service providers. Services manager 132 may provide a programmable, modular and integrated system for flexibly and securely exchanging data and associated services among access points 116, electronic devices 110, services manager 132 and the one or more computer systems 130. Note that resources in services manager 132 that are associated with different service providers may be contained in separate virtual machines. Alternatively or additionally, the resources from different service providers may be included in ‘containers’ (such as docker containers). Furthermore, the control and management plane and the data plane may be implemented in separate software stacks in services manager 132.

In some embodiments, optional controller 112 is used to configure settings of access points 116, such as transmit power, a transmit antenna pattern, a receive antenna pattern, etc. Thus, controller 112 may provide Wi-Fi control and management planes. Moreover, controller 112 may initialize IoT services that are facilitated and managed by services manager 132, i.e., services manager 132 may provide IoT data plane and control and management plane. In addition, services manager 132 may provide a partner portal for Wi-Fi and IoT management by one or more of computer systems 130. Note that in some embodiments, controller 112 may be combined with services manager 132 in a single device. Furthermore, note that controller 112 and/or services manager 132 may be local devices where access points 116 and electronic devices 110 are installed and used, or may be at a remote location (such as a cloud-based implementation).

In these ways, the communication techniques may enable the IoT. Notably, access points 116 and services manager 132 may provide a single-access network for Wi-Fi and IoT traffic. Access points 116 and services manager 132 may: manage network across different physical layers, provide IoT device-to-backend management, and/or distributed decision-making (such as at the edge immediately behind a firewall versus backend processing). Moreover, access points 116 and services manager 132 may be: transport protocol agnostic, architecture agnostic to the transport layer, and/or may support a variety of communication or transport protocols, such as Zigbee, BLE and/or other IoT communication protocols. Furthermore, access points 116 and services manager 132 may: provide a network backbone for a variety of services, enable end-to-end services for multiple connected ecosystems, and/or provide end-to-end solutions with a simplified value chain and a single network.

Moreover, the communication techniques may allow access points 116 and/or services manager 132 to provide flexible and secure exchange of data and the associated services. For example, the communication techniques may remove siloes between components from different manufacturers and providers (such as local electronic devices that provide IoT devices and actuators and service providers), and may facilitate dynamic services for customers (such as services that are configured and provided as needed). Furthermore, services manager 132 may facilitate interoperability of disparate components from different manufacturers and providers without requiring a standard or retrofitting of legacy equipment. Additionally, services manager 132 may eliminate the need for additional (and expensive) dedicated equipment (such as separate gateways for electronic devices from different manufacturers and/or additional network switches to connect to different cloud-based service providers). Thus, services manager 132 may enable integrated solutions and the IoT, which may allow a wide variety of valued-added applications and services, enhanced economic activity and enhanced user experiences and customer satisfaction.

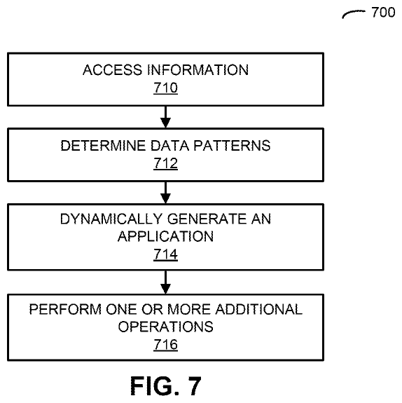

Furthermore, as described further below with reference to FIGS. 7-9, services manager 132 or another electronic device (such as one of the one or more computer systems 130) may dynamically generate an application for use with at least one of access points 116 and/or services manager 132. This application may include predefined component blocks or modules (e.g., one or more sets of program instructions) in one or more of access points 116 and/or services manager 132 to provide particular functionality based at least in part on communication among at least one of electronic devices 110, at least one of access points 116 and/or services manager 132, and/or data-transformation operations performed by at least one of electronic devices 110, at least one of access points 116 and/or services manager 132. Notably, the application may be dynamically generated based at least in part on data patterns that are determined by analyzing the communication among at least one of electronic devices 110, at least one of access points 116 and/or a gateway (such as the gateway in services manager 132). In some embodiments, the data patterns may specify an order, an interrelationship or both of the predefined component blocks or modules. Note that the data patterns may include configurations of one or more of the second electronic device, the access point or the gateway. Moreover, the application may be dynamically generated based at least in part on associated with the predefined component blocks or modules. For example, for a given predefined component block or module, the metadata may specify one or more internal functions and one or more interconnections to one or more other components. Additionally, the application may be dynamically generated based at least in part on parameters associated with a service, such as a service level agreement that specifies a communication performance (e.g., a throughput, a latency, a number of clients, etc.). After the application is generated, services manager 132 or the other electronic device may provide the application to at least the one of access points 116 or the gateway.

In this way, the communication techniques may allow the application to be dynamically (or on the fly) generated using building blocks (such as the component blocks or modules) using information (such as the metadata) about capabilities and interrelationships of the building blocks and measured data patterns. These capabilities may allow a variety of integrated applications or different instances of an application to be generated, which may allow scalable integrated solutions to be reliably created (e.g., by maintaining desired functionality). Thus, the communication techniques may reduce the time, cost and complexity of developing integrated applications, which may improve the performance and the user experience. Consequently, the communication techniques may facilitate the IoT.

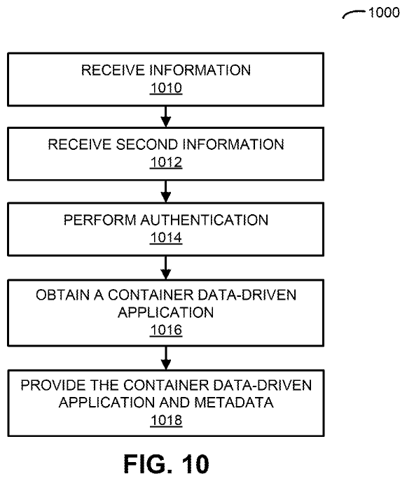

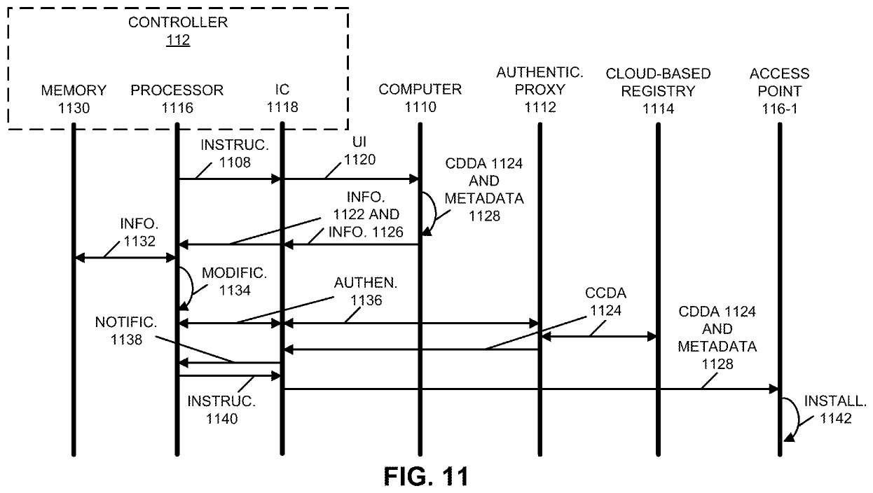

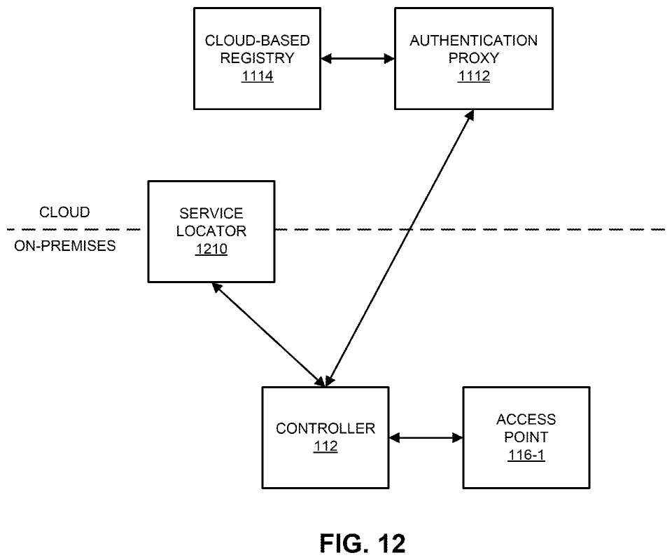

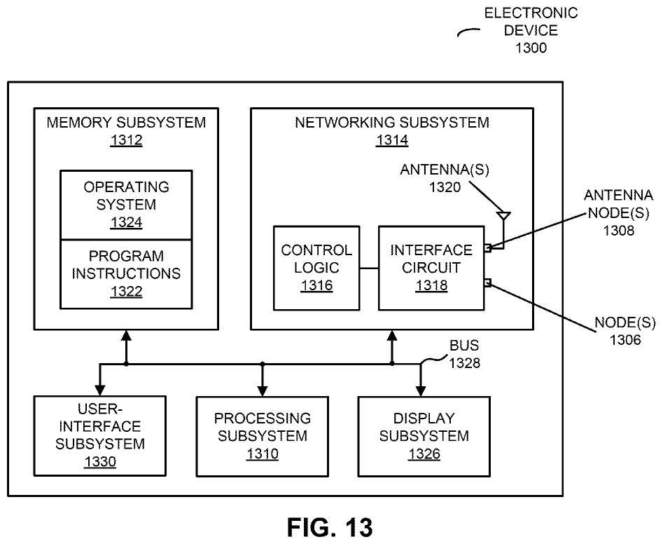

Additionally, as described further below with reference to FIGS. 10-12, instead of dynamically generating an application, controller 112 (and, more generally, a local or remotely located computer system) may be used to dynamically configure a computer network device (such as access point 116-1) with a containerized data-driven application and associated metadata. This containerized data-driven application may have been previously generated. During operation, controller 112 may receive information specifying the containerized data-driven application. Then, controller 112 may receive second information specifying metadata associated with the containerized data-driven application. For example, a user (such as a network operator or administrator) may provide the information and/or the second information via a user interface. In some embodiments, the second information may include one or more modifications to predefined metadata. Note that the metadata may specify resources that the containerized data-driven application is allowed to use on access point 116-1, such as: an amount of memory, a number of socket connections, a number of file managers, etc.

Moreover, controller 112 may perform authentication using an authentication proxy. Next, controller 112 may obtain, in a cloud-based registry of containerized data-driven applications, the containerized data-driven application. For example, the containerized data-driven application may be securely obtained from the cloud-based registry. Furthermore, controller 112 may provide, addressed to access point 116-1, the containerized data-driven application and the metadata, along with an instruction(s) to install the containerized data-driven application on access point 116-1. Note that the containerized data-driven application may extend the functionality of access point 116-1 beyond an initial set of predefined functions associated with hardware in access point 116-1.

In this way, the communication techniques may allow functions of access point 116-1 to be dynamically changed or modified. By dynamically repurposing access point 116-1, the communication techniques may allow access point 116-1 to have or provide improved and/or additional capabilities or services. Consequently, the communication techniques may improve the user experience when using access point 116-1 and may enable the IoT.

While the communication techniques in FIG. 1 are illustrated using access points 116 and services manager 132, in other embodiments at least some of the access points 116 may be eNodeBs (not shown). Moreover, an eNodeB may communicate with at least one of access points 116, e.g., using an LTE-WLAN aggregation (LWA) communication protocol or another cellular data communication protocol.

We now further describe embodiments of access points 116 and services manager 132. Current IoT-device gateways often operate within closed proprietary ecosystems, which can make it difficult to integrate a wide array of management platforms and disparate IoT-device networks. These problems are typically compounded by architectural limitations. For example, the gateways may have monolithic non-modular architectures that often are not scalable and customizable for different IoT-device network deployment scenarios, and these gateways are usually tied to expensive purpose-built hardware.

In order to address these challenges, access points 116 may aggregate and disburse data across disparate IoT devices, and may include data-acquisition and data transformation capabilities (such as a data acquisition and transformation engine or control logic). In addition, services manager 132 may include: a gateway abstraction service, an internal software development kit (SDK) that allows management of a control and management plane, and/or a partner services SDK that allows partner services providers to manage contained resources in services manager 132 that are associated with the respective partner services providers. Note that communication between services manager 132 and access points 116 may use a communication protocol, such as MQTT.

FIG. 2 presents a drawing illustrating an example of functionality of an access point 200, such as access point 116-1 in FIG. 1. Access point 200 may include an embedded IoT gateway and may provide an IoT-device management platform that is programmable and that can be easily integrated with existing management solutions. The core gateway functions in access point 200 may include: different communication-protocol stacks, a hardware for communication-protocol abstraction (which can provide a unified view of IoT devices to management platform), data acquisition (such as data aggregation and transformation), prioritization (data/traffic prioritization), management (which can access and set an electronic-device configuration), security (secure electronic-device authentication/actuation and cryptographic services, such as storing one or more encryption keys associated with particular electronic devices), data transport (such as MQTT), a connection manager and/or a gateway API services module and communication-protocol abstraction. In addition, access point 200 may include: an event manager core application (for different communication protocols, such as Zigbee or BLE), a profile manager for the different communication protocols, a security manager, a queue manager, an electronic-device registry, electronic-device discovery and/or a monitor that ensures safe and appropriate operation (such as by detecting an anomaly), and that tracks communication performance, etc.

In some embodiments, access point 200 may include a trusted secure element, WLAN firmware, an IoT gateway engine or control logic (such as one or more physical layer communication protocols) and an application layer that translates between different communication protocols. Note that a given access point may provide at least one communication protocol (in addition to Wi-Fi) via a USB dongle, and groups of access points may be interleaved to provide multiple different communication protocols.

After receiving information (such as IoT-device data or data traffic) from one or more of electronic devices 110 in FIG. 1, access point 200 may translate, into a unified format, the information associated with the one or more electronic devices 110, which may have been received by access point 200, at an interface circuit in access point 200, using different communication protocols. Then, access point 200 may send or communicate the translated information in a unified and consistent manner to a services manager, such as services manager 132 (FIG. 1). For example, access point 200 may provide, from an interface circuit in access point 200, the translated information for one or more additional electronic devices (such as services manager 132 in FIG. 1) using another communication protocol, such as MQTT.

In some embodiments, access point 200 (or services manager 132 in FIG. 1) may provide security by selectively including communication with an electronic device (such as electronic device 110-1 in FIG. 1) in an inclusion list and/or by selectively excluding communication with other electronic devices (such as electronic device 110-2 in FIG. 1) in an exclusion list. For example, the black and/or white lists may be applied by access point 200 following a scan.

FIG. 3 presents a block diagram illustrating an example of a Virtual Internet-of-Things (VIoT) services manager 300, such as services manager 132 in FIG. 1. This services manager may include: a gateway that communicates with one or more access points 116 (FIG. 1) via a communication protocol (such as MQTT); a control and management plane with system-configuration information; and a data plane with a registry of the one or more of electronic devices 110 (FIG. 1), rules for the one or more of electronic devices 110, and APIs for service providers. Services manager 300 may provide a programmable, modular and integrated system for flexibly and securely exchanging data and associated services among access points 116, electronic devices 110, services manager 132 or 300, and the one or more computer systems 130 in FIG. 1. Moreover, resources in services manager 300 that are associated with different service providers may be contained in separate virtual machines. Alternatively or additionally, the resources from different service providers may be included in ‘containers,’ such as docker containers. Note that a docker container may be a lightweight, stand-alone, executable package of a piece of software that includes everything needed to run it: code, runtime, system tools, system libraries, and settings. The containerized software may run the same, regardless of the environment. Containers also may isolate software from its surroundings, such as differences between development and staging environments, and may help reduce conflicts between different software that is running on the same infrastructure.

As noted previously, services manager 300 may include a control and management plane. The control and management plane may include: control management, an IoT physical layer, a gateway (such as a gateway engine, control logic or module), an IoT-device endpoint, and/or associated licenses. In addition, the control and management plane may provide system-architecture configuration, such as: transmit power, Internet Protocol or IP addresses, etc.

Moreover, services manager 300 may include a data plane with a partner SDK (for applications/services such as: a door lock, a thermostat, a light, analytical services, location-based services or LBS, cloud-based computing, etc.). Furthermore, the data plane may include rules, such as: an electronic-device registry (which may include device-specific information in device profiles), a rules engine or module, onboarding, authentication, an encryption engine or control logic, and store and forward.

Services manager 300 may be a dual-stack, open-programmable, virtualized IoT device-management gateway platform. It may be highly customizable, deployable in multiple network topologies, and may be integrated with existing management networks. The dual-stack, open-programmable, virtualized IoT device-management gateway platform may be an enterprise-grade IoT device-management platform. Note that services manager 300 may be a policy-driven virtualized wireless gateway that manages an IoT device network that includes one or more types of IoT devices from one or more manufacturers, and which may use different communication protocols. The open framework may facilitate IoT-device management in separate virtual machines, which may offer different vertical services.

In some embodiments, access point 200 (FIG. 2) and/or services manager 300 addresses a typical IoT device-network management system, which may include: wireless IoT devices, a physical communication layer, a network connectivity/protocol layer, and/or a gateway layer. Notably, access point 200 (FIG. 2) may include a data acquisition layer. For example, a data acquisition engine or control logic may enable gateway communication at scale with many IoT devices using disparate IoT-device connectivity or communication protocols (such as BLE, Zigbee, Z-Wave, etc.). This data acquisition layer may include the drivers and metadata information used to recognize and communicate with the different IoT-device types using different communication protocols.

Moreover, access point 200 (FIG. 2) may include an aggregation and translation layer. Notably, many of the IoT-device connectivity or communication protocols are rudimentary and fragmented. For example, Zigbee or 13L often does not provide support for IP. The aggregation and translation layer may perform the function of normalizing the data collected across these IoT devices. This block may perform packet processing and encapsulation functions for disparate incoming IoT-device packets and the output of this block may be normalized data in a standard format (such as MQTT) that is recognizable by a programmable application layer.

Furthermore, services manager 300 may include a programmable application layer. Notably, a smart-gateway abstraction service in services manager 300 may provide a full edge analysis engine or module. For example, the programmable application layer may implement blocks and functions, such as: a message broker, a rules engine or module, an onboarding engine or module, an electronic-device registry, a store and forward engine or module, and/or an encryption engine of control logic. Note that this layer may host a runtime environment and/or libraries that enable a third-party IoT SDKs, such as the partner service-provider SDKs. The routing of data packets to different third parties may be based at least in part on predefined policies specified by a user, such as a customer or a service-provider partner.

Additionally, services manager 300 may include an open management interface layer.

Services manager 300 may be a self-contained virtual machine that includes APIs that enable customers and/or service-provider partners to add another layer of contextualization/customization based at least in part on specific business needs. This flexibility may make services manager 300 highly programmable and rapidly deployable.

Note that services manager 300 may be architected as a dual-stack gateway. A first stack may include the data acquisition layer and the aggregation and translation layer. As discussed previously, the first stack may physically reside in a wireless access point (such as access point 200 in FIG. 2) and/or in on-premise gateway hardware.

A second stack may include the programmable application layer and the open management interface layer. Note that the second stack is a virtual machine that can reside on any of the wireless gateway hardware, such as access point 200 (FIG. 2), controller 112 (FIG. 1), services manager 300. Thus, the second stack may be on-premise, in a data center or may be cloud-based. Therefore, in general functionality of access point 200 (FIG. 2) and/or services manager 300 may be implemented by an arbitrary component, such as a local or a distributed electronic device or system.

The dual-stack architecture may provide flexibility to be deployed in an arbitrary network topology. In addition, this architecture may enable a distributed gateway architecture.

The core functions of the solution (which is sometimes referred to as an ‘IoT gateway’) implemented in access point 200 (FIG. 2) and services manager 300 may include: centralized management (secure onboarding management of IoT devices and gateways), data aggregation (aggregate and transform data from multiple gateways), edge analytics (process data at the edge, i.e., behind the firewall, from multiple gateways), hardware abstraction (provide unified view/management of different IoT-device types), and/or rules and alerts (create rules and alerts, predictive analysis, etc.).

The technology and capabilities of the solution implemented in access point 200 (FIG. 2) and services manager 300 may include: self-contained container/virtual machine that can be hosted anywhere (such as a controller, a switch, in the cloud, etc.). Moreover, the solution may have multi-tenants, which provides flexible deployment models and allows the use of a public and/or a private cloud. Furthermore, the solution may have the ability to host third-party SDKs and may provide a unified view of IoT devices/gateways. Additionally, the solution may incorporate edge computing capabilities (e.g., via a partner SDK and/or internal capability). The solution may be highly modular with a cloud-scale architecture.

In some embodiments, an open, programmable IoT gateway module may be programmed through a multitude of management platforms using one or more interfaces. Moreover, the IoT gateway may be capable of machine learning and intelligent decision making at the edge without backhauling information to the cloud, e.g., intelligent channel selection and assignment of channels across disparate wireless radios (such as Zigbee, Bluetooth, BLE, Wi-Fi, LoRaWAN, etc.). Furthermore, the IoT gateway may automatically detect anomalies and may dynamically use rules for creation/insertion to suppress anomalies. In addition, the IoT gateway may provide notifications, intelligent tracking and geo fencing of IoT and IoT-device assets. Additionally, the IoT gateway may intelligently identity and classify electronic devices, e.g., learning electronic-device characteristics based at least in part on communication patterns, association patterns, and/or beaconing patterns. These characteristics may be used to assign traffic from an electronic device to a queue with an appropriate queue latency. The IoT gateway may also prioritize electronic devices and/or electronic-device categories based at least in part on the learned characteristics, which may be used to prioritization of messages and/or message categories. In some embodiments, the IoT gateway may guarantee delivery of certain IoT messages, such as based at least in part on prioritization, intelligent classification and/or machine learning

FIG. 4 presents a block diagram illustrating an example of a software architecture of services manager 300. Notably, services manager 300 may include: an MQTT broker, a hardware abstraction layer API, an MQTT client, VIoT platform services (such as Java/Python runtime platform services), a gateway/IoT-device onboarding management, alerts/notifications, gateway/IoT-device actions, a rules engine/tracking/geo fencing, store and forward, and/or data transformation and filter. In addition, services manager 300 may include: third-party edge analytics, a RESTful API (which uses HTTP requests to GET, PUT, POST and DELETE data) for provisioning, actuation, statistics aggregation and management, a web server, an authentication subsystem, and/or a database. The third-party edge analytics may interface to external analytics services, the Web server may interface to one or more external cloud-based components, partner management portals, dashboard services and/or mobile applications. Note that the database may include information, such as: an electronic-device registry, telemetry data, electronic-device configuration, authentication, rules and/or profiles (e.g., electronic-device characteristics or device-specific information). In some embodiments, services manager 300 supports blockchain for highly secure environments.

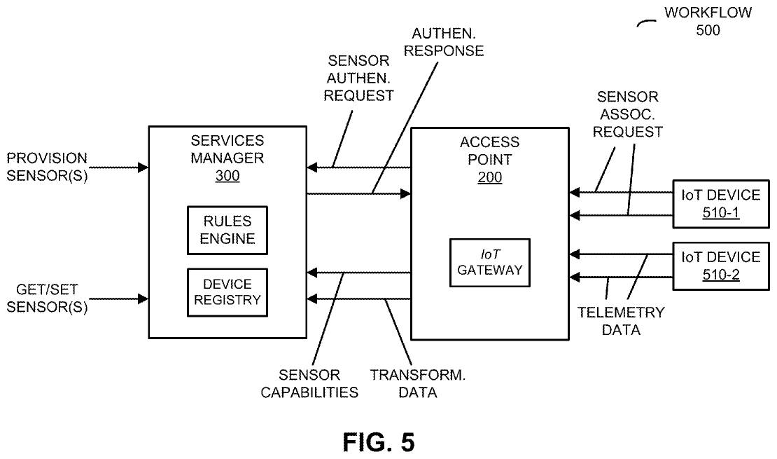

FIG. 5 presents a drawing illustrating an example of an onboarding work flow 500. Notably, IoT devices may be provisioned via an API call. Then, services manager 300 may create entry in an electronic-device registry. Moreover, one or more of IoT devices 510 may provide an IoT-device associate request to a gateway in access point 200. In response, access point 200 may provide an IoT-device authorization request to services manager 300, and may receive an authorization response. Next, access point 200 may provide information about IoT-device capabilities (and, more generally, characteristics of IoT devices 510). Furthermore, services manager 300 may receive an API call to get or set IoT devices, which may be forwarded to one or more of IoT devices 510. In response, one or more of IoT devices 510 (such as IoT device 510-2) may provide telemetry data. Associated transformed data may be provided by access point 200 to services manager 300. Additionally, services manager 300 may process the transformed data and/or may trigger local rules.

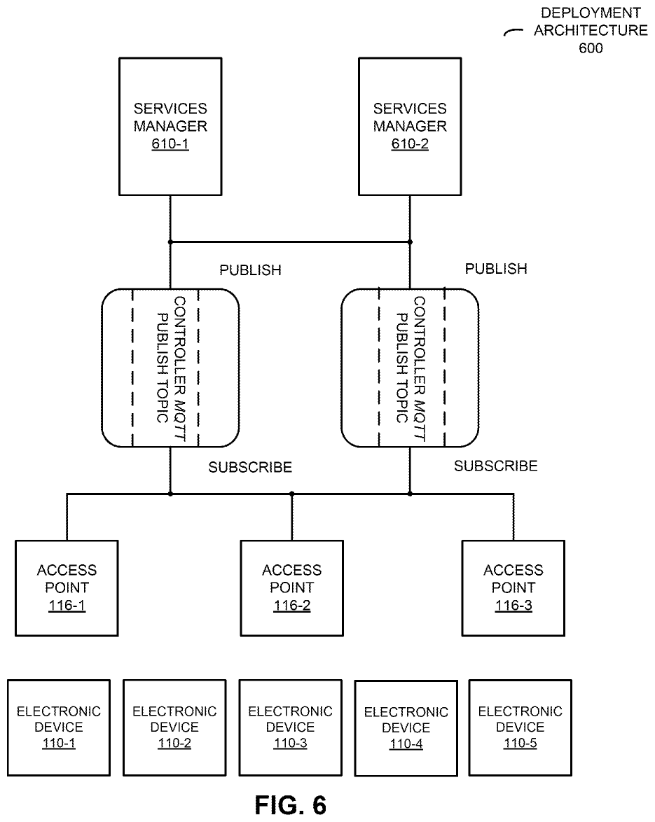

FIG. 6 presents a drawing illustrating an example of a deployment architecture 600. This architecture may include: one or more IoT devices or electronic devices 110 (which may include one or more sensors or sensing capabilities), one or more access points 116 (or gateways), and one or more services managers 610. Services managers 610 may publish or subscribe messages via controller MQTT publish topics. For example, services managers 610 may publish or subscribe messages using channels (which may be static or dynamic) having associated priorities.

Note that a given services manager (such as services manager 610-1) may dynamically configure subdomains in access points 116 and/or electronic devices 110 (FIG. 1) to define a range of communication using a communication protocol, such as MQTT. Alternatively or additionally, the given services manager may dynamically define channels for data traffic with access points 116 and/or electronic devices 110, where the channels are associated with different topics.

While the preceding embodiments illustrate access points 116 and services manager 132 as having particular components and a particular architecture, other embodiments may include fewer or more components, different components and/or a different architecture.

We now describe embodiments of methods associated with the communication techniques. FIG. 7 presents a flow diagram illustrating an example of a method 700 for dynamically generating an application, which may be performed by an electronic device, such as services manager 132 or one of the one or more computer systems 130 in FIG. 1. During operation, the electronic device may access information (operation 710) that specifies communication associated with a second electronic device, an access point and a gateway. For example, accessing the information may involve: receiving, at an interface circuit, the information; or determining the information by monitoring the communication.

Then, the electronic device may analyze the information to determine data patterns (operation 712) associated with the communication. Note that the data patterns may include communication operations and data-transformation operations performed by one or more of the second electronic device, the access point or the gateway. In some embodiments, the data patterns may specify an order, an interrelationship or both of the predefined component blocks or modules. Moreover, the data patterns may include configurations of one or more of the second electronic device, the access point or the gateway.

Next, the electronic device may dynamically generate an application (operation 714) using predefined component blocks or modules (e.g., one or more sets of program instructions) based at least in part on the determined data patterns and metadata associated with the predefined component blocks or modules. In some embodiments, the application may include bidirectional communication among two or more of the second electronic device, the access point and the gateway. Alternatively or additionally, the application may include multiple threads or processes, where a given thread is associated with a subset of the predefined component blocks or modules based at least in part on resource limitations of the second electronic device, the access point and/or the gateway. Note that, for a given predefined component block or module, the metadata may specify one or more internal functions and one or more interconnections to one or more other components.

In some embodiments, the electronic device may optionally perform one or more additional operations (operation 716). For example, the electronic device may provide, from the interface circuit, the application addressed to the access point or the gateway.

Moreover, the application may be dynamically generated based at least in part on parameters associated with a service. For example, the parameters may be associated with a service level agreement, such as a specified communication performance.

Furthermore, dynamically generating the application may involve: providing, from the interface circuit, a user interface that specifies the predefined component blocks or modules and the data patterns; and receiving, at the interface circuit, user-interface activity that specifies selections from the predefined component blocks or modules and the data patterns, where the application may be dynamically generated based at least in part on the specified selections.

In some embodiments of method 700 there may be additional or fewer operations. Furthermore, the order of the operations may be changed, and/or two or more operations may be combined into a single operation.

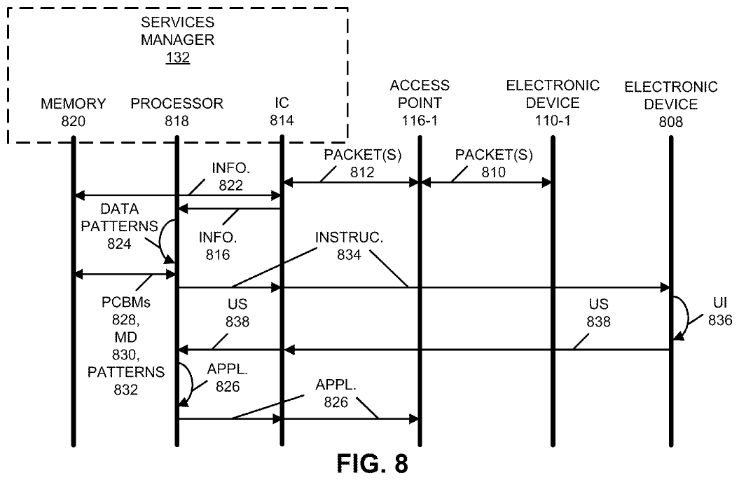

Embodiments of the communication techniques are further illustrated in FIG. 8, which presents a drawing illustrating an example of communication among electronic device 110-1, access point 116-1, services manager 132 and electronic device 808. Notably, electronic device 110-1 may communicate one or more packets 810 or frames with access point 116-1. Access point 116-1 may perform one or more data-transformation operations on information included in the one or more packets 810 or frames (such as changing an encoding or reformatting data for an application programming interface in a gateway in services manager 132). Moreover, access point 116-1 may communicate one or more packets 812 or frames with the gateway in services manager 132.

Interface circuit 814 in services manager 132 may monitor this communication (directly and/or indirectly, such as based at least in part on information about the communication provided by electronic device 110-1 and/or access point 116-1). Then, interface circuit 814 may provide information 816 about the communication to a processor 818 in services manager 132. Alternatively or additionally, processor 818 may access stored information 822 about the communication in memory 820 in services manager 132 prior to providing information 816.

Next, processor 818 may analyze information 816 and/or 822 to determine data patterns 824 associated with the communication. Moreover, processor 818 may dynamically generate an application 826 based at least in part on predefined component blocks or modules (PCBM) 828, data patterns 824, metadata (MD) 830 associated with the predefined component blocks or modules 828 and/or parameters 832 associated with a service and/or a service level agreement. Note that information about predefined component blocks or modules 828, metadata 830 and/or parameters 832 may be stored in memory 820 and may be accessed by processor 818.

In some embodiments, processor 818 dynamically generates application 826 by providing instructions 834 for a user interface (UI) 836 to interface circuit 814, which provides instructions 834 to electronic device 808, which may be associated with a user. Electronic device 808 may display user interface 836 based at least in part on instructions 834. Note that user interface 836 may include selectable user-interface objects associated with user-interface objects corresponding to predefined component blocks or modules 828 and information about (such as specifying or corresponding to) predetermined or predefined data patterns 824. Then, electronic device 808 may receive user-interface activity that specifies user selections (US) 838 in user interface 836. Moreover, electronic device 808 may provide user selections 838 to services manager 132. After receiving user selections 838, interface circuit 836 may provide user selections 838 to processor 818, which uses user selections 838 to dynamically generate application 826.

Furthermore, after dynamically generating application 826, processor 818 may provide, via interface circuit 814, application 826 to access point 116-1. Alternatively or additionally, processor 818 may execute application 826 and/or provide application 826 to a gateway in services manager 132, which may execute application 826.

Note that application 826 may integrate component blocks or modules associated with existing operations (such as communication and/or data-transformation operations) performed by access point 116-1 and/or services manager 132. Alternatively or additionally, application 826 may use data patterns 824 associated with the existing operations performed by access point 116-1 and/or services manager 132 to dynamically generate application 826 in order to specify new operations (such as communication and/or data-transformation operations) to be performed by access point 116-1 and/or services manager 132. For example, application 826 may leverage knowledge (at least in part in the form of data patterns 824) associated with an existing solution to dynamically generate a new instance of an integrated solution, such as an instance of the existing solution for use in a different operating environment (such as a different operating system), different system resources, with a different IoT device, and/or for a different use case.

While FIG. 8 illustrates communication between components using unidirectional or bidirectional communication with lines having single arrows or double arrows, in general the communication in a given operation in this figure may involve unidirectional or bidirectional communication.

As noted previously, while in some embodiments the electronic device dynamically generates the application in an automated manner (e.g., without user input or operations), in other embodiments the application is dynamically generated based at least in part on user selections. For example, the electronic device may provide instructions or information that specifies a user interface. This user interface may include selectable user-interface objects associated with predefined component blocks or modules and information specifying or corresponding to predetermined or predefined data patterns associated with communication associated with a second electronic device, an access point and a gateway. The user interface may be displayed on a display associated with a local electronic device (such as a computer associated with a user). In response, the user may user a user-interface device (such as a keyboard, a mouse, a touch pad, a track pad, a touch-sensitive display, a gesture monitoring device, a voice recognition interface, etc.) to provide the selections. A user-interface controller in the local electronic device may receive user-interface activity information that specifies selections of at least a subset of the predefined component blocks or modules, and the local electronic device may provide information specifying the user-interface activity to the electronic device, which then uses this information to dynamically generate the application.

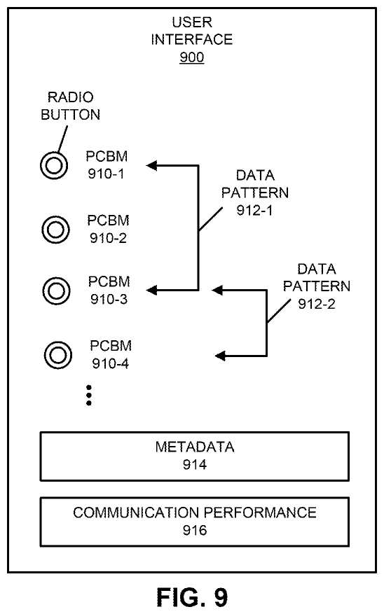

FIG. 9 presents a drawing illustrating an example of a user interface 900 that facilitates dynamic generation of an application. This user interface may include: selectable user-interface objects associated with predefined component blocks or modules 910 (such as one or more sets of program instructions that perform one or more corresponding functions) and information specifying or corresponding to predetermined or predefined data patterns 912 associated with communication associated with a second electronic device, an access point and a gateway. For example, the selectable user-interface objects associated with predefined component blocks or modules 910 may include one or more user-interface objects, such as: a radio button, a checkbox, a switch, a drop-down menu, a text-entry box, another type of selection control, etc.

Moreover, the predetermined or predefined data patterns 912 may include an order and/or an interrelationship of the predefined component blocks or modules 910. For example, the predetermined or predefined data patterns 912 may include communication operations and data-transformation operations performed by one or more of the second electronic device, the access point or the gateway. Additionally, the data patterns may include configurations of one or more of the second electronic device, the access point or the gateway. Note that the predefined component blocks or modules 910 may be based at least in part on the predetermined or predefined data patterns 912. Thus, user interface 900 may include the predefined component blocks or modules 910 that are likely to be of interest to the user and, therefore, that are likely to be selected and included in the application.

Furthermore, user interface 900 may include metadata 914 associated with the predefined component blocks or modules 910. For example, for a given predefined component block or module, metadata 914 may specify one or more internal functions and one or more interconnections to one or more other components. Thus, metadata 914 may indicate how the predefined component blocks or modules 910 work and how they can be interconnected to the one or more other components.

Additionally, user interface 900 may specify communication performance 916 associated with the selections, e.g., based at least in part on a service level agreement. For example, user interface 900 may specify a current communication performance associated with the current user selections relative to a desired communication performance (such as throughput, a capacity, a number of supported clients, a latency, etc.) associated with a service and/or a service level agreement.

In some embodiments, the selections may specify: bidirectional communication among two or more of the second electronic device, the access point and the gateway; and/or multiple threads or processes, where a given thread is associated with a subset of the predefined component blocks or modules based at least in part on resource limitations of the second electronic device, the access point and/or the gateway. For example, in the application, messages may be distributed to particular processes or threads based at least in part on message queue priorities.

While user interface 900 is illustrated with particular information and user-selection controls, in other embodiments user interface 900 may include: fewer or additional user-interface objects, different user-interface objects, two or more user-interface objects may be combined into a single user-interface object, a single user-interface object may be separated into two or more separate user-interface objects, and/or locations of one or more user-interface objects may be changed.

FIG. 10 presents a flow diagram illustrating an example of a method 1000 for dynamically configuring a computer network device with a containerized data-driven application and associated metadata, which may be performed by a computer system, such as controller 112 in FIG. 1. During operation, the computer system may receive information (operation 1010) specifying the containerized data-driven application. Then, the computer system may receive second information (operation 1012) specifying metadata associated with the containerized data-driven application. For example, the information and/or the second information may be received via a user interface. In some embodiments, the second information may specify one or more modifications to predefined metadata. Note that the metadata may specify resources that the containerized data-driven application is allowed to use on the computer network device, such as: an amount of memory, a number of socket connections, a number of file managers, etc.

Moreover, the computer system may perform authentication (operation 1014) using an authentication proxy. Next, the computer system may obtain, in a cloud-based registry of containerized data-driven applications, the containerized data-driven application (operation 1016). In some embodiments, the containerized data-driven application may be securely obtained from the cloud-based registry.

Furthermore, the computer system may provide, addressed to the computer network device, the containerized data-driven application and the metadata (operation 1018). Note that the computer network device may include: an access point, a gateway or a router.

Furthermore, the containerized data-driven application may execute in a virtual machine for the containerized data-driven application. This virtual machine may include an operating system for the containerized data-driven application.

Additionally, the metadata may be constrained based at least in part on one or more of: resources of the computer network device, one or more other applications installed on the computer network device, or one or more functions of the computer network device. For example, the information may include additional information that specifies the aforementioned resources, application and/or functions of the computer network device. Alternatively, the computer system may access the additional information.

Note that the containerized data-driven application may include: BLE monitoring of a BLE tag (which may provide operational intelligence about operations at an enterprise, such as: cleanliness, lighting, or resource availability, e.g., toilet paper, printer paper, etc.), a firewall, an analytics application, a radio resource manager that communicates using a communication protocol (e.g., Zigbee), or another micro-service.

Moreover, the containerized data-driven application may extend the functionality of the computer network device beyond an initial set of predefined functions associated with hardware in the computer network device.

In some embodiments of method 1000 there may be additional or fewer operations. Furthermore, the order of the operations may be changed, and/or two or more operations may be combined into a single operation.

Embodiments of the communication techniques are further illustrated in FIG. 11, which presents a drawing illustrating an example of communication among access point 116-1, controller 112, computer 1110, authentication proxy 1112 and cloud-based registry (or repository) 1114. Notably, processor 1116 in controller 112 may instruct 1108 interface circuit 1118 in controller 112 to provide information specifying a user interface (UI) 1120 to computer 1110. After receiving the information specifying user interface 1120, computer 1110 may display user interface 1120. Then, a user of computer 1110 may interact with user interface 1120 via a user-interface device in computer 1110 (such as a keyboard, a mouse, a trackpad, a touch pad, a stylus, a touch-sensitive display, a voice-recognition interface, or another human-interface device) to provide information 1122 specifying a containerized data-driven application (CDDA) 1124 and/or information 1126 specifying metadata 1128 associated with the containerized data-driven application 1124. For example, information 1126 may specify one or more modifications to predefined metadata. Note that metadata 1128 may specify resources that the containerized data-driven application 1124 is allowed to use on access point 116-1.

Moreover, computer 1110 may provide information 1122 and/or 1126 to controller 112. After receiving information 1122 and/or 1126, interface circuit 1118 may provide information 1122 and/or 1126 to processor 1116. In some embodiments, processor 1116 may access, in memory 1130 in controller 112, stored information 1132 about resources of access point 116-1, one or more other applications installed on access point 116-1, and/or one or more functions of access point 116-1. Then, processor 1116 may constrain or modify 1134 metadata 1128 based at least in part on information 1132. However, in some embodiments, the constraint and/or modification of metadata 1128 may be performed by computer 1110, e.g., via user interface 1120, which may include information 1132.

Furthermore, processor 1116 may perform, via interface circuit 1118, authentication 1136 with authentication proxy 1112. During authentication 1136, controller 112 may provide information that specifies the containerized data-driven application 1124 to authentication proxy 1112. Next, authentication proxy 1112 may obtain, in cloud-based registry 1114 of containerized data-driven applications, the containerized data-driven application 1124, which is then provided to controller 112.

After receiving the containerized data-driven application 1124, interface circuit 1118 may provide a notification 1138 to processor 1116. Then, processor 1116 may instruct 1140 interface circuit 1118 to provide, to access point 116-1, the containerized data-driven application 1124 and metadata 1128.

Additionally, after receiving the containerized data-driven application 1124 and metadata 1128, access point 116-1 may install 1142 the containerized data-driven application 1124 based at least in part on metadata 1128. In some embodiments, the containerized data-driven application 1124 may share a virtual machine with one or more other the containerized data-driven applications. Alternatively, in some embodiments, the containerized data-driven application 1124 may be executed by access point 116-1 in its own virtual machine.

While FIG. 11 illustrates communication between components using unidirectional or bidirectional communication with lines having single arrows or double arrows, in general the communication in a given operation in this figure may involve unidirectional or bidirectional communication.

In some embodiments, the communication techniques provide a data-driven solution for generating a vendor-specific application, instead of a tailor-made solution. Notably, by analyzing data patterns, preexisting or predefined component blocks or modules may be integrated to dynamically generate an application or a solution that provides desired functionality.

For example, packets or frames (and, more generally, traffic) associated with a panic button may have or may be compatible with a JavaScript Object Notation (JSON). An access point or a gateway (or controller) may reformat (and, more generally, may perform a data-transformation operation on) the packets or frames so that they are compatible with an API associated with the panic button. Alternatively, a message from an IoT device may be encoded using base 64, and the access point or the gateway may restructure or re-encode the message.

These operations (and, more generally, data patterns) may be determined by analyzing the communication among the panic button or IoT device (and, more generally, the second electronic device), the access point and/or the gateway (or services manager). Then, using a matrix of predefined component blocks or modules, metadata about the predefined component blocks or modules, data patterns (such as a communication speed of a serial link to a radio, a queue length, etc.), and/or parameters associated with a service or a service layer agreement (such as a real-time schedule, a quality of service, a throughput, a latency, a number of clients or IoT devices, etc.), a variety of integrated applications may be dynamically generated. Thus, in the communication techniques a system may be rearchitected into building blocks that can be ordered and/or interrelated and assembled into an application based at least in part on predefined component blocks or modules and data-driven assembly information.

In some embodiments, an application may be automatically generated. However, in other embodiments, an application may be generated based at least in part on user selections in a user interface of predefined component blocks or modules.

In some embodiments, the communication techniques address the problem of fast adaptation (in terms of go-to-market, engineering, configuration, and build-up into solutions) of a set of BLE-based service modules (which are sometimes referred to as ‘component blocks’ or ‘modules’), with potentially multiple instances and multiple vendor-device sets, service endpoints and/or deployment models. Notably, it is often difficult, expensive and costly to adapt a multi-service, multi-vendor, multi-application platform using simultaneous BLE services based at least in part on multiple instances of an arbitrary combination of connectionless and connected BLE communications, sending/receiving applications and/or multi-vendor end-device-related services. Note that any combination of these or other parameters may define a service. Moreover, the software for developing, deploying, maintaining, enabling/disabling, and configuring a set BLE-based service modules may be costly in terms of engineering, deployment, configuration, and maintenance. Furthermore, configuring an arbitrary application or service combination with overlapping functionalities may be unfeasible with discrete plugins or modules, each of which was built for a separate use case.

In the communication techniques, a data-driven adaptive multi-instance, multi-purpose dynamically configured BLE service adaptor-component may simultaneously and dynamically provide a complex set of services defined by a matrix of properties of predefined component blocks or modules, possibly with overlapping dimensions. Note that components of such a service-set matrix may include the dimensions (or metadata) of: a BLE-device vendor, model, and a use-case component identifying fingerprint, e.g., a vendor x iBeacon device accelerometer with a universal unique identifier (UUID) mask y; service communication characteristics, such as a direction of messages (e.g., this service component may be a scanner, connected transmitter, beacon-transmitter, etc.), a type of connectivity (connected, connectionless, hybrid, etc.), and/or a type of service-element use (generic attribute or GATT profile, a generic access or GAP profile, an opaque element field, etc.); a type of processing element, such as pass-through, responder, a message-modifying translator, an aggregator, filter, a message multiplicator, a real-time-communicator, a store-and-forward communicator, and/or another type of communication modifier); and/or a type of integrator (such as a vendor device to a vendor back-end connector, a multi-connector across vendors, a rule-driven multi-connector, etc.).

Moreover, in the communication techniques, a configuration engine may allow a dynamic adaptive multi-instance set of services to be configured, set to operation, managed, and/or deactivated as simultaneous elements of the matrix, which may be defined as an instance matrix with values for each dimension or multiple values for one or more dimensions. In practice, the configuration engine may enable an on-the-fly configuration of a BLE plugin or application, such that its properties can be mapped to the domain values of a multi-dimensional matrix and the configuration engine may implement the values as defined by this configuration data.

The communication techniques may provide or facilitate a fast definition and deployment cycle (with cost saving in development, testing, and deployment to use), compared to the current approach of a statically configured and developed per-vendor, per-purpose plugins or applications. Moreover, the communication techniques may also allow for overlap configurations that are typically difficult or unfeasible to implement as static configurations with separate purpose-built applications. Furthermore, the communication techniques may allow dynamic data-driven changes and/or experimental modes that may not be feasible in statically and discretely configured plugin sets or applications.

In some embodiments, a plugin or an application may listen to a set of vendor x beacons from BLE beacon devices with a UUID mask y, and may provide auxiliary beacons for wayfinding. The matrix with metadata for this service in the configuration engine may include: vendor: x, model: tray-beacon, UUID mask: y; message direction: beacon scanner (receiver) and beacon transmitter; message processing: pass-through, aggregator, filter, multiplexer-to-multiple service endpoint instances: and/or multiplexing: a vendor device to a vendor back-end pass-through.

The configuration engine may build a service from a highly parameterized set of dimensions (which may include predefined component blocks or modules). The communication techniques may address the problem of a BLE service-entity configuration in a IoT control-edge computing engine. These approaches are different from existing approaches in which a pluggable service infrastructure uses software elements or applications to provide a set of diverse IoT service and device-vendor use cases as discretely developed (tailor-made) solutions. In contrast, the communication techniques may allow the open, vendor-agnostic infrastructure and architecture of the services manager, with pluggable, programmable, and integrated applications to be dynamically adapted to a wide variety of use cases based at least in part on determined data patterns. These capabilities may provide a rapid deployment of service instances (such as instances of an application) with enterprise-quality integration.

Note that IoT deployments are major topics today across a variety of industries, including: consumer, industrial, enterprises and smart cites. With millions of devices to deploy, configure and manage, providing visibility and statistics at scale is often complicated and typically requires state-of-art networking and management systems.

Traditionally, applications that use communication protocols such as Zigbee and BLE are usually designed for smaller scale with a limited number of electronic device devices and with a gateway or a management device. Applications developed for Zigbee and BLE often attach to a Zigbee or BLE physical radio or an adapter of a gateway. This approach may be suitable for consumer and mobile application development with a limited number of electronic devices to manage and provide statistics. However, with the advent of the IoT and, in particular, in large-scale deployments, the traditional approach often does not serve the needs and scale of deployments in the areas of: electronic-device discovery; onboarding of electronic devices; radio-resource management; management of electronic-device attributes: and/or security.

In the communications techniques, the services manager may address these problems using a deployment architecture coupled with a networking concept of a virtual adapter and a unique set of virtual APIs and virtual attributes to enable IoT deployments at scale and with easier management. Notably, the services manager may include: a distributed software development kit (which may include a set of APIs, e.g., device scanning, device enumeration, device security and/or device provisioning, for manipulating a virtual adapter, virtual GATT profiles and attributes, one or more virtual electronic devices that wrap stack APIs for bulk management of electronic devices and fetching attributes); a virtual adapter (which may be an abstract object to which multiple physical adapters can be subscribed for easier management); a virtual GATT enumeration table (which may be an abstract object that enumerates electronic devices of the same class and provides a unified set of techniques for electronic-device management); virtual GATT attributes (which may be an abstract object that represents electronic-device attributes of the same class and that provides virtual identifiers); one or more virtual electronic devices (each of which may be an abstract class that provides techniques for managing virtual GATT attributes); and/or a physical adapter (which may be a real-world network radio and media access control (MAC) layer having a real-world UUID. Note that the virtual GATT enumeration table and/or the virtual GATT attributes may be provided by a virtual GATT server. Moreover, note that the services manager may include a virtual cluster server (such as for BLE, Zigbee, etc.).

In this way, the communication techniques may allow applications to be generated on the fly based at least in part on dynamically changing communication conditions and/or the operations performed by the second electronic device, the access point and/or the gateway. These capabilities may allow applications to be flexibly generated in a reliable and a scalable manner, which may enable large-scale deployments. Consequently, the communication techniques may improve the user experience and may enable the IoT.

In some embodiments, the communication techniques may allow a provider of an IoT device to rapidly and efficiently integrate instances of the IoT device with gateways via the services manager. For example, the IoT device may include a BTLE vital-sign monitor. Using a user interface (which may be provided by the services manager or another electronic device), a user may dynamically generate an application associated with the BTLE vital-sign monitor.

Notably, a user may provide information that specifies the BTLE vital-sign monitor (such as by providing information specifying one or more attributes associated with the BTLE vital-sign monitor and/or by selecting one or more predefined attributes that are associated with the BTLE vital-sign monitor, which may specify a type of the BTLE vital-sign monitor, and which are sometimes referred to as ‘metadata’), and then may activate a ‘scan’ icon (and, more generally, a user-interface object) in the user interface. In response, a virtual adapter in the services manager (or IoT controller) may propagate the scan instruction to multiple gateways (such as access points). These gateways may perform scans in one or more bands of frequencies for instances of the BTLE vital-sign monitor and/or other electronic devices.

When the scans are completed, the gateways may report back any discovered electronic devices, such as instances of the BTLE vital-sign monitor and/or the other electronic devices. Next, the user may activate a ‘filter out’ icon in the user interface. In response, the services manager may discard the other electronic devices that were discovered, so that the discovered instances of the BTLE vital-sign monitor remain.

Moreover, the user may activate a ‘connect’ icon in the user interface. In response, the virtual adapter in the services manager may instruct that gateways that discovered instances of the BTLE vital-sign monitor to establish connections with the instances of the BTLE vital-sign monitor.

Furthermore, the user may activate a ‘pairing’ icon in the user interface. In response, the services manager may select predefined pairing keys (such as SSH keys) and/or may generate pairing keys for the instances of the BTLE vital-sign monitor. Then, the virtual adapter in the services manager may provide the pairing keys to the gateways, which provide the pairing keys to the instances of the BTLE vital-sign monitor via the connections. Note that a given pairing key may allow an instance of the BTLE vital-sign monitor to establish an authenticated and secure connection with the services manager.

Additionally, the user may activate a ‘read data’ icon in the user interface. In response, the virtual adapter in the services manager may instruct one or more the gateways with one or more secure connections with one or more instances of the BTLE vital-sign monitor to import data (such as blood-pressure and/or heart-rate measurements). When the measurements are imported, they may be displayed in the user interface.

The services manager may then store these selected operations and the associated information (such as the attributes of the BTLE vital-sign monitor) as a configuration. This configuration may be associated with an API between the services manager and the gateways for the BTLE vital-sign monitor. Moreover, this API may enable automated execution of the selected operations as the application for the BTLE vital-sign monitor. For example, when a user subsequently activates the ‘read data’ icon in the user interface, the application may be invoked and the API, and one or more engines, modules or sets of program instructions in the API may perform operations including: scan, filter out, connect, pairing and read data.

In this way, the application may be dynamically generated. This application may eliminate the need for health-care providers to manually collect vital-sign measurements from instances of the BTLE vital-sign monitor.

In the preceding example, note that the icons in the user interface may be associated with or specify predefined component blocks or modules and information specifying or corresponding to predetermined or predefined data patterns associated with communication associated with the gateways and/or the BTLE vital-sign monitor, such as performing a scan, connecting, pairing and/or reading data. Moreover, the user selections of the icons may specify or define the predetermined or predefined data patterns.

In some embodiments, the communication techniques may provide the capability to host a general purpose applications securely on an enterprise edge node (such as an access point, a gateway, or a router) that has wired and wireless interfaces. Typically, edge nodes are purpose built networking electronic devices to service one particular use case. For example, access points are purpose built to connect user equipment (such as smart phones, computers, laptops, home audio/video equipment) and provide (Wi-Fi) access. Such purpose-built edge devices are very common in large/small enterprises, commercial buildings and homes. These electronic devices normally operate on AC power, PoE (Power over Ethernet), etc. and also have Ethernet backhaul to connect to the Internet. However, there is a growing demand to use these purpose built edge devices to add/provide additional capabilities over what they were originally intended for, e.g., an IoT gateway, a firewall, an analytic engine, etc. on purpose-built Wi-Fi equipment.

While the disclosed communication techniques address the cost of deployment, total cost of ownership and improved operating efficiency, there may be concerns around bandwidth (CPU, memory, etc.) sharing, shared access to critical resources (such as network/radio interfaces) and security (such as malware insertion, root-user privilege access, phishing/snooping, software updates/firmware management, etc.). Therefore, the disclosed communication techniques may address the aforementioned problems, thereby allowing secure hosting of applications on an enterprise edge node, such as an access point (which is used as an illustration) and/or other types of edge nodes. Notably, the communication techniques may provide: a secure location for firmware management; image signing of firmware; one or more user interfaces for orchestrating an application on an access point; providing metadata and one or more user interfaces for resource and bandwidth limiting; providing one or more user interfaces for starting, stopping, restarting and collecting events and logs from one or more applications; and/or a secure communication channel for handling user traffic.

FIG. 12 presents a drawing illustrating an example of communication among computer 1110, access point 116-1, controller 112, service locator 1210, authentication proxy 1112 and cloud-based registry 1114. This communication may dynamically configure access point 116-1 with a containerized data-driven application and associated metadata. Note that the metadata may specify resources that the containerized data-driven application is allowed to use on access point 116-1, such as: an amount of memory, a number of socket connections, a number of file managers, etc. For example, Table I provides an example of a metadata tile that specifies the resources that a containerized data-driven application is allowed to access.

```
version: “3.1”
services:
  docker_service:
    image: $DOCKER_IMAGE
    container_name: $DOCKER_CONTAINER
    network_mode: “host”
    security_opt:
      - seccomp:/writable/feature/iot/seccomp_profile_config.json
    deploy:
      resources:
        limits:
          cpus: $DOCKER_CPU
          memory: $DOCKER_MEMORY
    cap_drop:
      - ALL
    cap_add:
      - NET_RAW
      - NET_BIND_SERVICE
      - KILL
    tmpfs:
      - /proc/br_dnat/
      - /proc/ci
      - /proc/rflow
      - /proc/rks_nl
      - /proc/rks_qosmos
      - /proc/rks_sptun
      - /proc/rks_timestamp
      - /proc/rkscalea
      - /proc/rksgre
      - /proc/rudb
      - /proc/v54bsp
      - /proc/wifi0
      - /proc/wifi1
      - /proc/wlan0
      - /proc/wlan1
      - /proc/wlan10
      - /proc/wlan100
      - /proc/wlan101
      - /proc/wlan102
      - /proc/wlan11
      - /proc/wlan12
      - /proc/wlan13
      - /proc/wlan14
      - /proc/wlan15
      - /proc/wlan2
      - /proc/wlan3
      - /proc/wlan4
      - /proc/wlan5
      - /proc/wlan6
      - /proc/wlan7
      - /proc/wlan8
      - /proc/wlan9
      - /sys
    ports:
      - “62397:62307”
      - “10001:10001”
      - “48812:48812”
    volumes:
      - $DOCKER_VOLUME_MAP:/data/docker_volume
    extra_hosts:
      - “ap_iot_mqttbroker:$DOCKER_EXTRA_HOST”
```

During operation, controller 112 (and, more generally, a local or remotely located computer system, such as an edge electronic device) may provide a user interface to computer 1110. This user interface may allow computer 1110 to specify the containerized data-driven application and the associated metadata. Note that the metadata may be specified by one or more modifications to predefined metadata.

In some embodiments, the user interface may constrain the specified metadata based at least in part on resources of access point 116-1, one or more other applications installed on access point 116-1, and/or one or more functions of access point 116-1. Alternatively or additionally, in some embodiments the user interface may dynamically constrain the specified metadata based at least in part on a load of access point 116-1 and/or feedback information about communication performance of access point 116-1 (which may be received from a cloud-based analytics service), such as: a number or associated clients or stations, a throughput or a utilization of access point 116-1, etc.

Then, controller 112 may receive, from computer 1110, information specifying the containerized data-driven application and/or second information specifying the metadata associated with the containerized data-driven application.

Alter receiving the information and/or the second information, controller 112 may retrieve, from service locator 1210 (which be locally or remotely located from controller 112), an address or location (such as a uniform resource locator or URL) of authentication proxy 1112. Next, controller 112 may perform authentication using authentication proxy 1112. This authentication may confirm that access point 116-1 (or a user, a company or an organization associated with access point 116-1) is authorized to receive the containerized data-driven application. Note that communication between controller 112 and authentication proxy 1112 may occur via a management channel over gRPC remote procedure call. In some embodiments, this communication may occur via a gRPC tunnel.

Moreover, after successful authentication, authentication proxy 1112 may obtain the containerized data-driven application from cloud-based registry 1114, which secure stores one or more containerized data-driven applications. For example, authentication proxy 1112 may obtain docker commands corresponding to the containerized data-driven application. Furthermore, authentication proxy may provide the containerized data-driven application (such as the docker commands) to controller 112.

Additionally, after receiving the containerized data-driven application, controller 132 may provide the containerized data-driven application (such as the docker commands) to access point 116-1. For example, the containerized data-driven application may be provided to access point 116-1 using secure MQTT and/or HyperText Transfer Protocol Secure (HTTPS) communication.

Thus, the containerized data-driven application may be pushed to access point 116-1 with metadata that indicates the resources the containerized data-driven application can use on access point 116-1. Consequently, controller 132 may act as a proxy for the containerized data-driven application.

Note that the containerized data-driven application may extend the functionality of access point 116-1 beyond an initial set of predefined functions associated with hardware in access point 116-1. Thus, the communication techniques may allow the capabilities, functions and/or services of access point 116-1 to be dynamically changed or modified. For example, the communication techniques may allow one or more micro-service(s) for an application to be dynamically installed (or removed) from access point 116-1 and, more generally, a computer network device.

While the preceding discussion illustrated controller 112 performing operations in the communication techniques, in other embodiments at least some of these operations are performed by services manager 132 (FIG. 1). Moreover, in some embodiments, service locator 1210 and/or authentication proxy 1112 are excluded. Thus, in some embodiments, controller 312 may be authenticated and/or may receive the containerized data-driven application directly from the cloud-based registry 1114. Furthermore, while a containerized data-drive application was used as an illustration of the communication techniques, in other embodiments the application may not be data-driven.

We now describe embodiments of an electronic device, which may perform at least some of the operations in the communication techniques. FIG. 13 presents a block diagram illustrating an example of an electronic device 1300 in accordance with some embodiments, such as one of: base station 108, one of electronic devices 110, controller 112, one of access points 116, one of radio nodes 118, computer network device 128, one of the one or more computer systems 130 or services manager 132. This electronic device includes processing subsystem 1310, memory subsystem 1312, and networking subsystem 1314. Processing subsystem 1310 includes one or more devices configured to perform computational operations. For example, processing subsystem 1310 can include one or more microprocessors, graphics processing units (GPUs), ASICs, microcontrollers, programmable-logic devices, and/or one or more digital signal processors (DSPs).

Memory subsystem 1312 includes one or more devices for storing data and/or instructions for processing subsystem 1310 and networking subsystem 1314. For example, memory subsystem 1312 can include DRAM, static random access memory (SRAM), and/or other types of memory. In some embodiments, instructions for processing subsystem 1310 in memory subsystem 1312 include: one or more program modules or sets of instructions (such as program instructions 1322 or operating system 1324, such as Linux, UNIX, Windows Server, or another customized and proprietary operating system), which may be executed by processing subsystem 1310. Note that the one or more computer programs, program modules or instructions may constitute a computer-program mechanism. Moreover, instructions in the various modules in memory subsystem 1312 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1310.

In addition, memory subsystem 1312 can include mechanisms for controlling access to the memory. In some embodiments, memory subsystem 1312 includes a memory hierarchy that comprises one or more caches coupled to a memory in electronic device 1300. In some of these embodiments, one or more of the caches is located in processing subsystem 1310.

In some embodiments, memory subsystem 1312 is coupled to one or more high-capacity mass-storage devices (not shown). For example, memory subsystem 1312 can be coupled to a magnetic or optical drive, a solid-state drive, or another type of mass-storage device. In these embodiments, memory subsystem 1312 can be used by electronic device 1300 as fast-access storage for often-used data, while the mass-storage device is used to store less frequently used data.

Networking subsystem 1314 includes one or more devices configured to couple to and communicate on a wired and/or wireless network (i.e., to perform network operations), including: control logic 1316, an interface circuit 1318 and one or more antennas 1320 (or antenna elements). (While FIG. 13 includes one or more antennas 1320, in some embodiments electronic device 1300 includes one or more nodes, such as antenna nodes 1308, e.g., a metal pad or a connector, which can be coupled to the one or more antennas 1320, or nodes 1306, which can be coupled to a wired or optical connection or link. Thus, electronic device 1300 may or may not include the one or more antennas 1320. Note that the one or more nodes 1306 and/or antenna nodes 1308 may constitute input(s) to and/or output(s) from electronic device 1300.) For example, networking subsystem 1314 can include a Bluetooth networking system, a cellular networking system (e.g., a 3G/4G/5G network such as UMTS, LTE, etc.), a universal serial bus (USB) networking system, a coaxial interface, a High-Definition Multimedia Interface (HDMI) interface, a networking system based on the standards described in IEEE 802.11 (e.g., a Wi-Fi® networking system), an Ethernet networking system, a Zigbee networking system, a Z-Wave networking system, a LoRaWAN networking system and/or another networking system.

Note that a transmit or receive antenna pattern (or antenna radiation pattern) of electronic device 1300 may be adapted or changed using pattern shapers (such as directors or reflectors) and/or one or more antennas 1320 (or antenna elements), which can be independently and selectively electrically coupled to ground to steer the transmit antenna pattern in different directions. Thus, if one or more antennas 1320 include N antenna pattern shapers, the one or more antennas may have 2^{N} different antenna pattern configurations. More generally, a given antenna pattern may include amplitudes and/or phases of signals that specify a direction of the main or primary lobe of the given antenna pattern, as well as so-called ‘exclusion regions’ or ‘exclusion zones’ (which are sometimes referred to as ‘notches’ or ‘nulls’). Note that an exclusion zone of the given antenna pattern includes a low-intensity region of the given antenna pattern. While the intensity is not necessarily zero in the exclusion zone, it may be below a threshold, such as 3 dB or lower than the peak gain of the given antenna pattern. Thus, the given antenna pattern may include a local maximum (e.g., a primary beam) that directs gain in the direction of electronic device 1300 that is of interest, and one or more local minima that reduce gain in the direction of other electronic devices that are not of interest. In this way, the given antenna pattern may be selected so that communication that is undesirable (such as with the other electronic devices) is avoided to reduce or eliminate adverse effects, such as interference or crosstalk.

Networking subsystem 1314 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 1300 may use the mechanisms in networking subsystem 1314 for performing simple wireless communication between the electronic devices, e.g., transmitting advertising or beacon frames and/or scanning for advertising frames transmitted by other electronic devices as described previously.

Within electronic device 1300, processing subsystem 1310, memory subsystem 1312, and networking subsystem 1314 are coupled together using bus 1328. Bus 1328 may include an electrical, optical, and/or electro-optical connection that the subsystems can use to communicate commands and data among one another. Although only one bus 1328 is shown for clarity, different embodiments can include a different number or configuration of electrical, optical, and/or electro-optical connections among the subsystems.

In some embodiments, electronic device 1300 includes a display subsystem 1326 for displaying information on a display, which may include a display driver and the display, such as a liquid-crystal display, a multi-touch touchscreen, etc.

Moreover, electronic device 1300 may include a user-interface subsystem 1330, such as: a mouse, a keyboard, a trackpad, a stylus, a voice-recognition interface, and/or another human-machine interface. In some embodiments, user-interface subsystem 1330 may include or may interact with a touch-sensitive display in display subsystem 1326.

Electronic device 1300 can be (or can be included in) any electronic device with at least one network interface. For example, electronic device 1300 can be (or can be included in): a desktop computer, a laptop computer, a subnotebook/netbook, a server, a tablet computer, a cloud-based computing system, a smartphone, a cellular telephone, a smartwatch, a wearable electronic device, a consumer-electronic device, a portable computing device, an access point, a transceiver, a router, a switch, communication equipment, an eNodeB, a controller, test equipment, and/or another electronic device.

Although specific components are used to describe electronic device 1300, in alternative embodiments, different components and/or subsystems may be present in electronic device 1300. For example, electronic device 1300 may include one or more additional processing subsystems, memory subsystems, networking subsystems, and/or display subsystems. Additionally, one or more of the subsystems may not be present in electronic device 1300. Moreover, in some embodiments, electronic device 1300 may include one or more additional subsystems that are not shown in FIG. 13. Also, although separate subsystems are shown in FIG. 13, in some embodiments some or all of a given subsystem or component can be integrated into one or more of the other subsystems or component(s) in electronic device 1300. For example, in some embodiments instructions 1322 is included in operating system 1324 and/or control logic 1316 is included in interface circuit 1318.

Moreover, the circuits and components in electronic device 1300 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 1314 and/or of electronic device 1300. The integrated circuit may include hardware and/or software mechanisms that are used for transmitting wireless signals from electronic device 1300 and receiving signals at electronic device 1300 from other electronic devices. Aside from the mechanisms herein described, radios are generally known in the art and hence are not described in detail. In general, networking subsystem 1314 and/or the integrated circuit can include any number of radios. Note that the radios in multiple-radio embodiments function in a similar way to the described single-radio embodiments.

In some embodiments, networking subsystem 1314 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Wi-Fi and/or Ethernet communication protocols as illustrative examples, in other embodiments a wide variety of communication protocols and, more generally, communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 1322, operating system 1324 (such as a driver for interface circuit 1318) or in firmware in interface circuit 1318. Alternatively, or additionally, at least some of the operations in the communication techniques may be implemented in a physical layer, such as hardware in interface circuit 1318.

Furthermore, the functionality of electronic device 1300 may be implemented using a single electronic device or a group of electronic devices, which may be located at a single location or which may be distributed at disparate geographic locations (such as a cloud-based computing system).

Note that the use of the phrases ‘capable of’ ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

While examples of numerical values are provided in the preceding discussion, in other embodiments different numerical values are used. Consequently, the numerical values provided are not intended to be limiting.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer system, comprising:
an interface circuit that communicates with a computer network device;
a processor coupled to the interface circuit; and
memory, coupled to the processor, configured to store program instructions, wherein, when executed by the processor, the program instructions cause the computer system to perform operations, comprising:
receiving information specifying a containerized data-driven application;
receiving second information specifying metadata associated with the containerized data-driven application;
performing authentication using an authentication proxy;
obtaining, in a cloud-based registry of containerized data-driven applications, the containerized data-driven application; and
providing, addressed to the computer network device, the containerized data-driven application and the metadata.

2. The computer system of claim 1, wherein the computer network device comprises: an access point, a gateway or a router.

3. The computer system of claim 1, wherein the metadata specifies resources that the containerized data-driven application is allowed to use on the computer network device.

4. The computer system of claim 1, wherein the containerized data-driven application executes in a virtual machine for the containerized data-driven application; and
wherein the virtual machine comprises an operating system for the containerized data-driven application.

5. The computer system of claim 1, wherein the metadata is constrained based at least in part on one or more of: resources of the computer network device, one or more other applications installed on the computer network device, or one or more functions of the computer network device.

6. The computer system of claim 1, wherein the computer system comprises a controller of the computer network device that configures and manages operation of the computer network device.

7. The computer system of claim 1, wherein the containerized data-driven application comprises: Bluetooth low energy (BLE) monitoring of a BLE tag, a firewall, an analytics application, a radio resource manager that communicates using a communication protocol, or another micro-service.

8. The computer system of claim 1, wherein the containerized data-driven application is securely obtained from the cloud-based registry.

9. The computer system of claim 1, wherein the containerized data-driven application extends functionality of the computer network device beyond an initial set of predefined functions associated with hardware in the computer network device.

10. The computer system of claim 1, wherein the receiving of the information, the second information, or both occurs via a user interface.

11. The computer system of claim 1, wherein the second information specifies one or more modifications to predefined metadata.

12. A non-transitory computer-readable storage medium for use in conjunction with a computer system, the computer-readable storage medium storing program instructions that, when executed by the computer system, cause the computer system to perform operations comprising:
receiving information specifying a containerized data-driven application;
receiving second information specifying metadata associated with the containerized data-driven application;
performing authentication using an authentication proxy;
obtaining, in a cloud-based registry of containerized data-driven applications, the containerized data-driven application; and
providing, addressed to a computer network device, the containerized data-driven application and the metadata.

13. The non-transitory computer-readable storage medium of claim 12, wherein the computer network device comprises: an access point, a gateway or a router.

14. The non-transitory computer-readable storage medium of claim 12, wherein the metadata specifies resources that the containerized data-driven application is allowed to use on the computer network device.

15. The non-transitory computer-readable storage medium of claim 12, wherein the containerized data-driven application executes in a virtual machine for the containerized data-driven application; and
wherein the virtual machine comprises an operating system for the containerized data-driven application.

16. A method for dynamically configuring a computer network device with a containerized data-driven application and associated metadata, comprising:
by a computer system:
receiving information specifying the containerized data-driven application;
receiving second information specifying the metadata associated with the containerized data-driven application;
performing authentication using an authentication proxy;
obtaining, in a cloud-based registry of containerized data-driven applications, the containerized data-driven application; and
providing, addressed to the computer network device, the containerized data-driven application and the metadata.

17. The method of claim 16, wherein the computer network device comprises: an access point, a gateway or a router.

18. The method of claim 16, wherein the metadata specifies resources that the containerized data-driven application is allowed to use on the computer network device.

19. The method of claim 16, wherein the containerized data-driven application executes in a virtual machine for the containerized data-driven application; and
wherein the virtual machine comprises an operating system for the containerized data-driven application.

20. The method of claim 16, wherein the metadata is constrained based at least in part on one or more of: resources of the computer network device, one or more other applications installed on the computer network device, or one or more functions of the computer network device.
